(19) United States
(12) Patent Application Publication
(10) Pub. No.: US 2007/0101403 A1
(43) Pub. Date: May 3, 2007

(54) Provisioning a wireless link for a wireless scanner

(75) Inventor: Joseph J. Kubler, Boulder, CO (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: INTERMEC IP CORP.

(21) Appl. No.: 11/266,828

(22) Filed: Nov. 3, 2005

(51) Int. Cl. H04L 9/32

(52) U.S. Cl. 726/3; 235/375; 235/462.46; 713/184; 455/41.1

(57) ABSTRACT

A system and method of provisioning a wireless link for a wireless scanner is provided. Embodiments of the present invention operate in accordance with a primary wireless device adapted to generate security data at the beginning of a session, an output device electrically connected to the primary wireless device, and a secondary wireless device adapted to communicate with the primary wireless device over a wireless link. In one embodiment of the present invention, the primary wireless device includes a provisioning application connected to a first wireless device and adapted to (i) generate security data at the beginning of a session, (ii) provide the security data to the first wireless device, and (iiii) provide the security data to the output device. In alternate embodiments of the present invention, the provisioning application is further adapted to (i) store the security data in a memory device, (ii) provide instructional information to the output device, and/or (ii) generate a barcode(s) that includes the security data, at least one provisioning command, and/or additional data. In another embodiment of the present invention, the second wireless device includes a scanning application connected to a second wireless device and adapted to (i) acquire the security data from the output device, (ii) identify the security data as being applicable to the second wireless device, and (iii) provide the security data to the second wireless device. In an alternate embodiment of the present invention, the scanning application is further adapted to store the security data in a memory device.

### BACKGROUND OF THE INVENTION

1. Field of the Invention

The present invention relates to wireless scanning devices, and more particularly, to a system or method of provisioning a wireless link for a wireless scanner by automatically generating security data at the beginning of a session, providing security data to an output device, scanning the security data, and using the security data to establish a (preferably secure) wireless connection between the wireless scanner and a host.

2. Description of Related Art

Wireless technology is becoming more and more prevalent. One concern with wireless technology, however, is the security of the information that is being transmitted. This is because the information is being transmitted over radio frequency (RF) signals that are accessible to anyone with a proper reception device. In response to this concern, many wireless protocols (e.g., Bluetooth, ZigBee, WLAN, etc.) have implemented security procedures that can be activated on command.

Bluetooth, for example, uses a personal identification number (PIN) to authenticate a secondary device. Specifically, the PIN of a primary device is manually provided to the secondary device (e.g., by way of a keyboard). The primary device then transmits a “challenge” that is based (in part) on the PIN. The secondary device then transmits a “response” that is based (in part) on the “challenge” and the PIN. If the “response” is proper (or authenticated), the secondary device is authenticated, and a relatively secure wireless link is established. If additional security is required, the PIN can be used to generate an encryption key, which is used to encrypt (or encode) data that is transmitted over the link. Similar security procedures are found in other wireless protocols.

One drawback of these security procedures is that they are based on PINs (or codes), which like any other password, should be changed frequently in order to ensure a certain level of security. Thus, a procedure needs to be in place in which new PINs are identified on a routine basis.

Another drawback, which only exacerbates the first drawback, is that the new PINs need to be entered manually (e.g., by way of a keyboard). This is especially problematic in a manufacturing or shipping environment, where wireless devices (e.g., wireless scanners, etc.) are used in numbers and frequently (if not continuously). If the security procedures, which require individuals to frequently (i) identify a number of new PINs and (ii) manually entering the new PINs into a number of wireless devices, becomes too cumbersome, the procedures will either be disregarded or they will be followed haphazardly. For example, the PINs may end up being relatively simple (e.g., “0000,” “123456”), repetitive, identified and entered less frequently, or never changed.

Accordingly, it would be desirable to provide a system and method of provisioning a wireless link between a host and a wireless device, preferably a wireless scanner, that overcomes at least one of these drawbacks.

### SUMMARY OF THE INVENTION

The present invention provides a system and method of provisioning a wireless link for a wireless scanner. Embodiments of the present invention operate in accordance a primary wireless device (e.g., a host) adapted to generate security data at the beginning of a session, an output device (e.g., a display, printer, etc.) electrically connected to the primary wireless device, and at least one secondary device (e.g., a scanner) adapted to communicate with the primary wireless device over a wireless link.

The term “session” is used herein to connote a (static or dynamic) period of time. The session may be user-defined, so that a new session begins, for example, every hour, every day, at the beginning of a shift, etc. The session may alternately (or also) be based on the reception of user-defined data, so that a new session begins, for example, when an employee logs (or clocks) in, when a new (or different) wireless scanner is identified, when a “provisioning” key or icon is selected, etc. The session may alternately (or also) be based on the occurrence of an event (e.g., power outage, security breach, etc.). The term “security data” is used herein to connote any number, code or data that is used to enhance (or establish a level of) security in a wireless link. For example, with respect to the Bluetooth protocol, a personal identification number (PIN) is used for authentication and encryption, and would therefore constitute security data. Similar (security) data is used in conjunction with other wireless protocols.

In a first embodiment of the present invention, a host includes a provisioning application connected to a first wireless device and adapted to (i) generate security data at the beginning of a session, (ii) provide the security data to the first wireless device, and (iii) display the security data on a display. In alternate embodiments of the present invention, the provisioning application is further adapted to (i) store the security data in a memory device, (ii) display instructional information on the display, and/or (iii) generate a barcode(s) that includes the security data, at least one provisioning command, and/or additional data.

In a second embodiment of the present invention, a scanner includes a scanning application connected to a second wireless device and adapted to (i) acquire encoded data (e.g., a barcode, etc.), (ii) extract the security data from the encoded data, (iii) identify the security data as being applicable to the second wireless device, and (iv) provide the security data to the second wireless device. In an alternate embodiment of the present invention, the scanning application is further adapted to store the security data in a memory device. If the barcode(s) includes a provisioning command(s), the scanning application may use the command(s) to identify the security data as being applicable to the second wireless device and/or the second wireless device may use the command(s) to identify the security data as being applicable to provisioning a wireless link (e.g., for authentication, encryption, etc.).

In a third embodiment of the present invention, the scanning application is further adapted to acquire additional encoded data from a third device (e.g., printer, etc.) and provide the additional data to the host over a secure wireless link. In one embodiment of the present invention, the additional encoded data is used by the host to establish a connection with the third device.

A more complete understanding of a system and method of provisioning a wireless link for a wireless scanner will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 illustrates a system for provisioning a wireless link between a host and a scanner in accordance with one embodiment of the present invention;

FIG. 2 illustrates a block diagram of a host and a block diagram of a scanner (see FIG. 1) in accordance with embodiments of the present invention; and

FIG. 3 illustrates a method of provisioning a wireless link in accordance with one embodiment of the present invention.

### DETAILED DESCRIPTION OF THE PREFERRED EMBODIMENT

The present invention provides a system and method of provisioning a wireless link for a wireless scanner. In the detailed description that follows, like element numerals are used to describe like elements illustrated in one or more figures. It should be appreciated that while embodiments of the present invention are described herein in term of a Bluetooth protocol, the present invention is not so limited, and is further applicable to all wireless protocols including, but not limited to, WiFi, WLAN, ZigBee, and all other wireless protocols generally known to those skilled in the art.

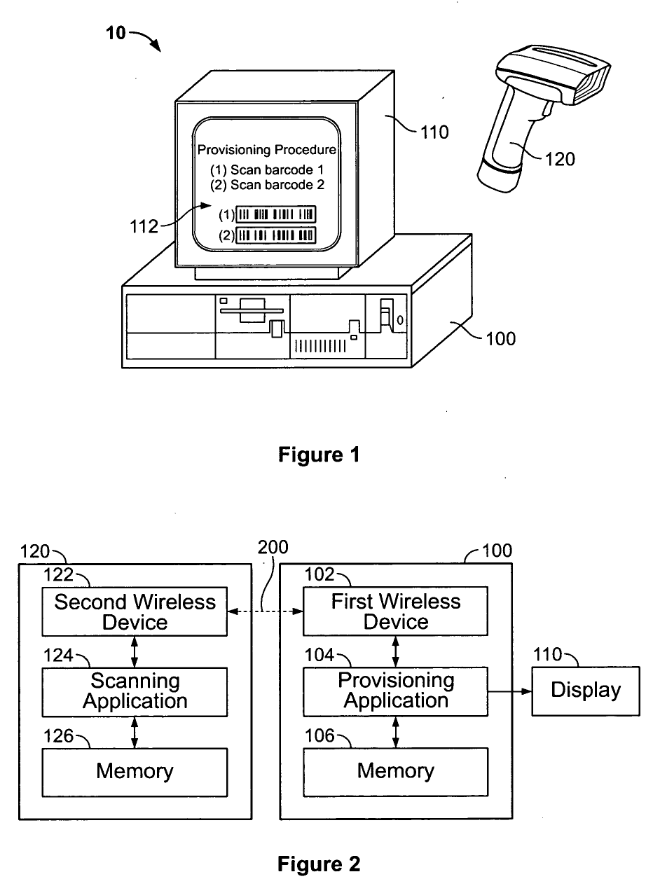

Embodiments of the present invention operate in accordance with an output device (e.g., display, printer, etc.), a primary wireless device (e.g., a host) connected to the output device, and at least one secondary wireless device (e.g., a scanner). FIG. 1 illustrates a system for provisioning a wireless link in accordance with one embodiment of the present invention. Specifically, the system 10 includes a host 100, a display 110 electrically connected to the host 100, and a scanner 120 adapted to communicate with the host 100 over a wireless link. It should be appreciated that the displays discussed and depicted herein include, but are not limited to, computer monitors (e.g., CRTs, flat-panels, etc.), small graphic displays (e.g., 240×320, etc.), alphanumeric displays, and all other display devices generally known to those skilled in the art. It should also be appreciated that the hosts discussed and depicted herein include, but are not limited to, personal computers (desktops, laptops, etc.), hand-held computers (e.g., PDAs, etc.) and all other computing and/or processing devices generally known to those skilled in the art. It should further be appreciated that the wireless scanners discussed and depicted herein include, but are not limited to, wireless barcode scanners, wireless RFID scanners, and all other wireless optical, electrical and/or radio frequency scanning devices generally known to those skilled in the art.

In accordance with a first embodiment of the present invention, the host 100 is adapted to generate security data at the beginning of a session. The term “session” is used herein to connote a (static or dynamic) period of time. The session may be user-defined, so that a new session begins, for example, every hour, every day, at the beginning of a shift, etc. The session may alternately (or also) be based on the reception of user-defined data, so that a new session begins, for example, when an employee logs (or clocks) in, when a new (or different) wireless scanner is identified, when a “provisioning” key or icon is selected, etc. The session may alternately (or also) be based on the occurrence of an event (e.g., power outage, security breach, etc.). The term “security data” is used herein to connote any number, code or data that is used to enhance (or establish a level of) security in a wireless link. For example, with respect to the Bluetooth protocol, a personal identification number (PIN) is used for authentication and encryption, and therefore constitute security data. Similar (security) data is used in conjunction with other wireless protocols.

The security data is then displayed on the display 110. In a preferred embodiment of the present invention, the security data is displayed in the form of at least one barcode. In other words, the host 100, in this embodiment, is adapted to (i) generate security data, (ii) generate at least one barcode that includes at least the security data, and (iii) display the at least one barcode on the display 110. In another embodiment of the present invention, the host 100 is further adapted to generate a barcode(s) that includes both the security data and at least one provisioning command. The provisioning command is used by the scanner 120 (or components included therein) to identify the security data as data that is applicable to a wireless device or can be used to provision a wireless link. In another embodiment of the present invention, the host 100 is further adapted to display instructional information on the display. Such an embodiment is exemplified in FIG. 1, where the display 110 includes instructional information (e.g., “Provisioning Procedures 1) Scan barcode 1 . . . ”) and a plurality of barcodes (e.g., barcodes 1 and 2) (i.e., 112). The barcodes include security data and may also include at least one provisioning command and/or additional information.

The wireless device 120 is then used to scan an image of the barcode(s) on the display 110. The security data is then extracted from the barcode(s) and used to provision a wireless link between the scanner 120 and the host 100. For example, if the scanner 120 includes Bluetooth technology, the security data (e.g., a PIN) may be used to generate a “response” to a “challenge” transmitted by the host 100. It may also be used to facilitate encryption.

FIG. 2 illustrates a block diagram of the host and a block diagram of the scanner in accordance with embodiments of the present invention. Specifically, in accordance with one embodiment of the present invention, the host includes a first wireless device 102, a provisioning application 104 and a memory device 106. The provisioning application 104 is adapted to (i) generate security data at the beginning of a session, (ii) provide the security data to the first wireless device 102, and (iii) display the security data on the display 110. In alternate embodiments of the present invention, the provisioning application is further adapted to (i) store the security data in the memory device 106, (ii) display instructional information on the display 110, and/or (iii) generate a barcode(s) that includes the security data, at least one provisioning command, and/or additional data.

In accordance with another embodiment of the present invention, the scanner 120 includes a second wireless device 122, a scanning application 124 and a memory device 120. The scanning application 124 is adapted to (i) acquire barcode data, (ii) extract (e.g., decode) the security data from the barcode data, (iii) identify the security data as being applicable to the second wireless device, and (iii) provide the security data to the second wireless device. In an alternate embodiment of the present invention, the scanning application 124 is further adapted to store the security data in the memory device 126. If a provisioning command(s) is provided, the scanning application 124 may use the command(s) to identify the security data as being applicable to the second wireless device 122 and/or the second wireless device 122 may use the command(s) to identify the security data as being applicable to provisioning a wireless link (e.g., for authentication, encryption, etc.).

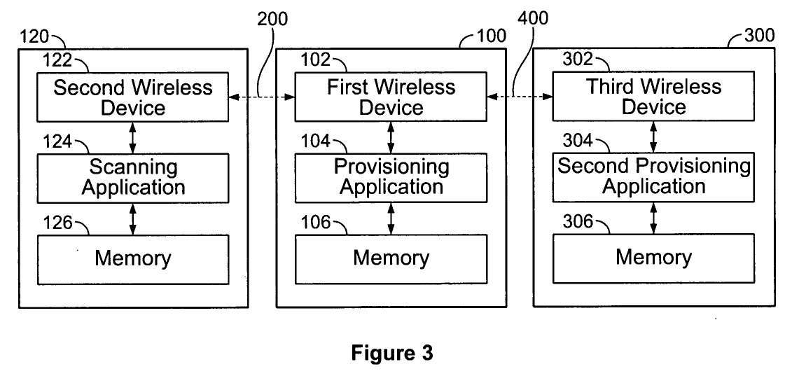

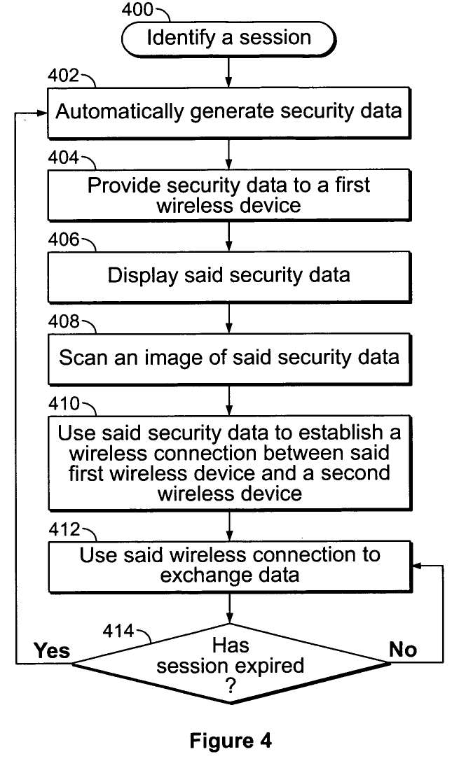

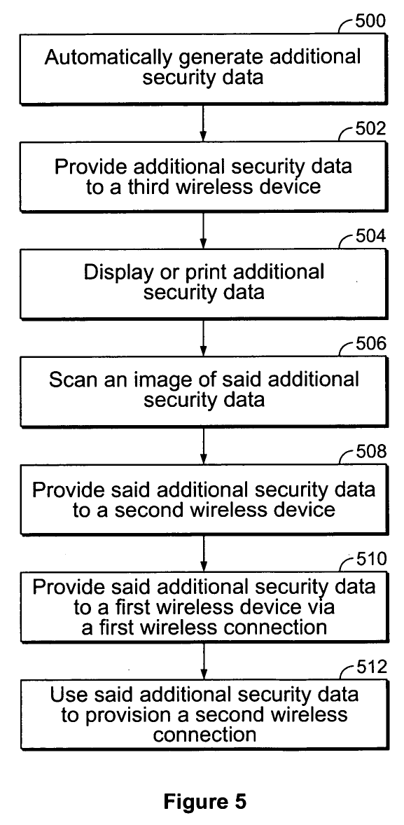

In accordance with another embodiment of the present invention, as shown in FIG. 3, additional security data is used to provision a wireless link between the host 100 and a third device (e.g., computer, smart printer, etc.). Specifically, the third device 300 includes a third wireless device 302, a second provisioning application 304 and a memory 306. The provisioning application 304 is adapted to (i) generate additional security data (e.g., at the beginning of a session, etc.), (ii) provide the additional security data to the third wireless device 302, and (iii) display or print the additional security data. In an alternate embodiment of the present invention, the second provisioning application 304 is further adapted to (i) store the additional security data in the memory device 306, (ii) display or print instructional information, and/or (iii) generate a barcode(s) that includes the additional security data, at least one provisioning command, and/or additional data.

The scanner application 124, in accordance with this embodiment, is further adapted to (i) acquire the additional security data (e.g., by scanning a barcode that includes the additional security data, etc.) and (ii) provide the additional security data to the second wireless device 122. The second wireless device 122 is then adapted to provide the additional security data to the first wireless device 102 via the wireless link 200. The additional security data is then used to provision a wireless link 400 between the first wireless device 102 and the third wireless device 302. If a provisioning command(s) is provided, the scanning application 124 may use the command(s) to identify the additional security data as being applicable to the second wireless device 122, the second wireless device 122 may use the command(s) to identify the additional security data as being applicable to the first wireless device 102, and/or the first wireless device 102 may use the command(s) to identify the additional security data as being applicable to provisioning a wireless link (e.g., for authentication, encryption, etc.).

It should be appreciated that the wireless devices (e.g., 102, 122) depicted and discussed herein include, but are not limited to, Bluetooth transceivers and all other wireless reception and/or transmission devices generally known to those skilled in the art. It should also be appreciated that the memory devices (e.g., 106, 126) depicted and discussed herein include, but are not limited to, RAM, cache memory, flash memory, magnetic disks, optical disks, removable disks, SCSI disks, IDE hard drives, registers and all other data storage devices (and combinations thereof, such as RAID devices) generally known to those skilled in the art. It should further be appreciated that the number, locations and types of components depicted in FIG. 2 are not limitations of the present invention, and are merely provided to illustrate the environment in which the present invention may operate. Thus, for example, a host that includes additional or fewer components (e.g., a plurality of memory devices, a user interface, etc.) is considered within the spirit and scope of the present invention. It should further be appreciated that the provisioning application may exist as a single application or as multiple applications operating locally on and/or remotely to the host. Thus, for example, a provisioning system that includes a host, a server in communication with the host, and at least a portion of a provisioning application operating on the server, is considered within the spirit and scope of the present invention.

A method of provisioning a wireless link in accordance with one embodiment of the present invention is illustrated in FIG. 4. Specifically, a session (e.g., a first session, etc.) is identified at step 400. As previously discussed, a session may begin at a pre-determined time, in response to the reception of user-defined data (e.g., data indicating that a new (or different) scanner is being use, data indicating that a “provisioning” key or icon has been selected, etc.), and/or in response to a particular event. At step 402, security data is automatically generated. In preferred embodiments of the present invention, the security data is generated at the beginning of or during the session. At steps 404 and 406, respectively, the security data is provided to a first wireless device and displayed on a display device. The first wireless device may use the security data to perform at least one security procedure (e.g., generate and transmit a “challenge,” etc.). In one embodiment of the present invention, the security data is encoded (e.g., in a barcode, etc.) prior to being displayed on the display device.

An image of the security data (or an encoded version thereof) is then scanned at step 408 and used to establish a wireless connection between the first wireless device and a second wireless device at step 410. For example, the second wireless device may use the security data to perform at least one security procedure (e.g., generate and transmit a “response” to the “challenge,” etc.). The wireless link can then be used to exchange data at step 412 until the session has expired or a new session has begun. At step 414, and at that time, security data (e.g., new security data) is automatically generated at step 402, and the process begins again.

A method of provisioning a wireless link in accordance with a second embodiment of the present invention is illustrated in FIG. 5. Specifically, additional security data is automatically generated at step 500 and provided to a third wireless device at step 502. At step 504, the additional security data is then displayed or printed (e.g., on a display, by a printer, by a smart printer, etc.). An image of the additional security data, as displayed or printed, is then scanned at step 506 and provided to a second wireless device at step 508. At steps 510 and 512, respectively, the additional security data is provided to a first wireless device via a first wireless link (e.g., between the first wireless device and the second wireless device) and used to provision a second wireless link (e.g., between the first wireless device and the third wireless device).

Having thus described several embodiments of a system and method of provisioning a secure wireless link for a wireless scanner, it should be apparent to those skilled in the art that certain advantages of the within described system and method have been achieved. It should also be appreciated that various modifications, adaptations, and alternative embodiments thereof may be made within the scope and spirit of the present invention. The invention is solely defined by the following claims.

What is claimed is:

1. A system for provisioning a wireless connection between a host and a scanner, comprising:
a display device;
a host connected to said display device and comprising a first wireless device and a provisioning application, said provisioning application being adapted to:
automatically generate security data at the beginning of a session;
provide said security data to said first wireless device; and
display said security data on said display device; and
a scanner comprising a second wireless device and a scanning application, said scanning application being adapted to:
scan an image of said security data on said display device; and
provide said security data to said second wireless device, said security data being used by said first and second wireless devices to establish a secure wireless connection therebetween.

2. The system of claim 1, wherein said host further comprises a memory device and said provisioning application is further adapted to store said security data in said memory device.

3. The system of claim 1, wherein said first and second wireless devices are Bluetooth transceivers and said security data comprises a personal identification number (PIN).

4. The system of claim 1, wherein said session comprises a user-defined period of time.

5. The system of claim 1, wherein said provisioning application is further adapted to create said session in response to receiving user-defined data.

6. The system of claim 1, wherein said provisioning application is further adapted to generate at least one barcode that includes said security data and to display said security data on said display device by displaying said at least one barcode on said display device.

7. The system of claim 3, wherein said provisioning application is further adapted to display at least one provisioning command on said display device, an image of said at least one provisioning command being scanned by said scanner and used to identify said security data as said PIN.

8. The system of claim 7, wherein said provisioning application is further adapted to display instructional information on said display device, said instructional information instructing a user to scan said image of said security data on said display device.

9. The system of claim 1, wherein said scanner further comprises a memory device, said scanning application being further adapted to store said security data in said memory device.

10. The system of claim 1, wherein said security data is used by said first wireless device to authenticate said second wireless device.

11. The system of claim 1, wherein said security data is used to encrypt data that is transmitted at least unidirectionally over said secure wireless connection.

12. The system of claim 1, further comprising a third wireless device and a second provisioning application adapted to (i) automatically generate additional security data, (ii) provide said additional security data to said third wireless device, and (iii) print said additional security data.

13. The system of claim 13, wherein said scanning application is further adapted to scan an image of said additional security data and provide said additional security data to said second wireless device, said additional security data being provided to said first wireless device via said secure wireless connection and used to establish a second wireless connection between said first wireless device and said third wireless device.

14. A method of provisioning a wireless connection between a host and a scanner, comprising:
automatically generating security data that corresponds to a session;
providing said security data to a first wireless device, said first wireless device being in communication with said host;
displaying said security data on a display device;
acquiring said security data by scanning an image of said security data on said display device;
identifying said security data as being applicable to a second wireless device, said second wireless device being in communication with said scanner;
providing said security data to said second wireless device; and
using said security data to establish a secure wireless connection between said first and second wireless devices.

15. The method of claim 14, wherein said step of automatically generating security data further comprises automatically generating a personal identification number (PIN), said PIN being used, at least in part, by said first wireless device to authenticate said second wireless device.

16. The method of claim 14, wherein said step of automatically generating security data further comprises automatically generating a personal identification number (PIN), said PIN being use, at least in part, to encrypt data that is transmitted at least unidirectionally over said secure wireless connection.

17. The method of claim 14, wherein said step of automatically generating security data that corresponds to a session further comprises automatically generating said security data that corresponds to a user-defined session.

18. The method of claim 14, further comprising the step of receiving user-defined data, wherein said step of automatically generating security data that corresponds to a session further comprises automatically generating said security data that corresponds to the reception of said user-defined data.

19. The method of claim 14, wherein said step of displaying said security data on a display device further comprises generating at least one barcode that includes said security data and displaying said at least one barcode on said display device.

20. The method of claim 14, wherein said steps of displaying said security data on a display device and identifying said security data as being applicable to a second wireless device further comprises:
generating at least one barcode that includes said security data and at least one provisioning command;
displaying said at least one barcode on said display device; and
using said at least one provisioning command to identify said security data as being applicable to said second wireless device.

21. The method of claim 20, wherein said step of displaying said security data on a display device further comprises displaying instructional information on said display device that instructs a user to scan an image of said at least one barcode on said display device.

22. The method of claim 14, further comprising:
automatically generating additional security data;
providing said additional security data to a third wireless device;
printing said additional security data on a substantially flat substrate;
acquiring said additional security by scanning an image of said additional security data on said substantially flat substrate;
providing said additional security data to said first wireless device via said secure wireless connection; and
using said additional security data to establish a second secure wireless connection between said first and third wireless devices.

23. A host connected to a display device, comprising:
a Bluetooth transceiver; and
a provisioning application connected to said Bluetooth transceiver, said provisioning application being adapted to:
automatically generate a personal identification number (PIN) at the beginning of a session;
providing said PIN to said Bluetooth transceiver, said Bluetooth transceiver using said PIN to generate a challenge;
generating at least one barcode that includes at least said PIN;
displaying said at least one barcode on said display device;
wherein said PIN is used by a scanner to generate a response to said challenge, which is then used by said Bluetooth transceiver to authenticate said scanner.
